(19) United States
(12) Patent Application Publication
(10) Pub. No.: US 2020/0135392 A1
(43) Pub. Date: Apr. 30, 2020

(54) Coil Device for a Motor Vehicle, in Particular for a Car

(71) Applicant: Bayerische Motoren Werke Aktiengesellschaft, Muenchen (DE)

(72) Inventors: Detlef HELM, Mauth (DE); Josef KRAMMER, Holzkirchen (DE); Tobias MUELLER-KABEITZ, Landau (DE)

(21) Appl. No.: 16/728,628

(22) Filed: Dec. 27, 2019

Related U.S. Application Data
(63) Continuation of application No. PCT/EP2018/067352, filed on Jun. 28, 2018.

(30) Foreign Application Priority Data
Jun. 30, 2017 (DE) 10 2017 211 208.5

(51) Int. Cl. H01F 38/14; B60L 53/12; B60L 53/38; H01F 27/02; H01F 27/255; H01F 27/26; H02J 50/10

(52) U.S. Cl. CPC H01F 38/14; B60L 53/12; B60L 53/38; H02J 50/10; H01F 27/255; H01F 27/263; H01F 27/02

(57) ABSTRACT

A coil device for a motor vehicle has a housing, at least one secondary coil which is arranged in the housing for inductively transmitting electric energy in order to charge an energy storage unit of the motor vehicle, and a plurality of ferrites, which are arranged in the housing and which are mutually spaced, for conducting at least one magnetic field in order to inductively transmit the electric energy. The ferrites form a flat element and are connected together via at least one elastically deformable connection element such that the ferrites can be moved relative to one another while elastically deforming the connection element.

### CROSS REFERENCE TO RELATED APPLICATIONS

This application is a continuation of PCT International Application No. PCT/EP2018/067352, filed Jun. 28, 2018, which claims priority under 35 U.S.C. § 119 from German Patent Application No. 10 2017 211 208.5, filed Jun. 30, 2017, the entire disclosures of which are herein expressly incorporated by reference.

### BACKGROUND AND SUMMARY OF THE INVENTION

The invention relates to a coil device for a motor vehicle, in particular for a car.

A coil device for a motor vehicle, in particular for a car, is already known for example from DE 10 2013 226 830 A1. The coil device has a housing and at least one secondary coil which is arranged in the housing and by which electrical energy can be inductively transmitted for the purposes of charging an energy store of the motor vehicle. For this purpose, the secondary coil interacts, for example, with a primary coil arranged on a floor, by virtue of electrical energy, which is provided for example from an energy source by means of the primary coil, being inductively transmitted from the primary coil to the secondary coil. From the secondary coil, the electrical energy is then for example transmitted to the energy store and stored in the energy store. The coil device furthermore has a plurality of ferrites which are arranged in the housing and which are spaced apart from one another and which serve for conducting, in particular shielding, at least one magnetic field for the inductive transmission of the electrical energy. In other words, for the inductive transmission of the electrical energy, at least one magnetic field is generated which is conducted or shielded by way of the ferrites.

US 2012/0235636 A1 discloses a system for charging and/or operating one or more appliances by means of wireless energy. Furthermore, J P 2012 257 445 A has disclosed a fastening structure for fastening a contactless charger to a vehicle. Furthermore, DE 20 2007 001 542 U1 discloses an inductive component, in particular an antenna, having a coil body which is formed as an elongate structural part provided with at least one interior space.

It is an object of the present invention to improve a coil device of the type mentioned in the introduction.

According to an aspect of the invention, the coil device has the ferrites form an areal element, that is to say a panel element, which has for example an at least substantially two-dimensional extent. This is to be understood in particular to mean that the panel element (areal element) has, in two spatial directions running perpendicular to one another, respective extents which are significantly greater than a third extent running in a further spatial direction running perpendicular to the spatial directions. Furthermore, the coil device has at least one flexible or elastically deformable connecting element by which the ferrites, which are for example themselves spaced apart from one another and form the panel element, are connected to one another, such that the ferrites are movable relative to one another with elastic deformation of the connecting element. In other words, if the ferrites are moved relative to one another, the connecting element is elastically deformed as a result. In other words again, the connecting element permits relative movements between the ferrites, such that the ferrites can be moved relative to one another with elastic deformation of the connecting element, whilst the ferrites remain connected to one another by way of the connecting element.

The background to the invention is in particular the fact that the secondary coil is commonly arranged on an underfloor of the motor vehicle, which is for example in the form of a car, in particular a passenger car, such that the secondary coil can interact in a particularly advantageous manner with a primary coil of an inductive charging unit. By means of the charging unit, electrical energy, which is provided for example from an energy source by way of the primary coil, can be inductively transmitted from the primary coil to the secondary coil and fed to the energy store, which is for example in the form of a battery, in particular a high-voltage battery, of the motor vehicle and stored in the energy store. The primary coil is commonly arranged on a floor, for example of a parking space, of a parking block, of a garage, etc. The secondary coil is commonly exposed to all weather conditions and force influences, in particular if an object that is situated on a roadway along which the motor vehicle is being driven collides with the secondary coil or with the coil device.

The secondary coil is preferably formed from copper or comprises copper in order to realize particularly advantageous electrical conductivity. For the inductive transmission of the electrical energy, at least one magnetic field is generated which can be conducted, in particular shielded, by use of the ferrites. A particularly efficient transmission of energy can be realized in this way. The ferrites are commonly brittle and thus at risk of breakage. This means that the ferrites can easily break under the action of force. Furthermore, power electronics are commonly provided, in particular in the motor vehicle or in the housing, wherein such power electronics may also be exposed to weather conditions and actions of force. It is commonly the case that no or only insufficient protection of the ferrites is provided.

To now be able to keep the likelihood of damage to, or destruction of, the ferrites occurring particularly low, the ferrites form—as described—the panel element and are connected to one another, so as to be movable relative to one another, by means of the connecting element, such that a segmented construction or a segmented arrangement of the ferrites is provided. By means of the formation of the panel element and the segmented construction, it is for example possible for a force acting on the coil device to be accommodated in a particularly advantageous manner by the coil device, in particular by the ferrites. Such a force acting on the coil device arises for example if an object arranged on a roadway along which the motor vehicle is moving initially collides with the coil device. At a location at which the object collides with the coil device, it is for example possible for the panel element, or the ferrites, to yield to the force, because the connecting element permits a relative movement between the ferrites. The ferrites and the connecting element that connects the ferrites form, for example, a structural unit which, in particular at the stated location, can yield to or deflect under the action of force. In this way, an overly intense exertion of force on a single one of the ferrites can be avoided, such that the likelihood of breakage of the ferrites or of the individual ferrite can be considerably reduced in relation to conventional coil devices.

In the case of the coil device according to the invention, it is thus possible to realize particularly advantageous protection of the stated structural unit and thus of the ferrites with respect to external influences, in particular external actions of force. The ferrites themselves are rigid elements of the structural unit. The rigid elements are connected to one another in the described manner by means of the connecting element. Since the connecting element is elastically deformable, the structural unit as a whole is flexible or elastically deformable, such that forces acting on the structural unit from the outside can be accommodated and distributed in a particularly advantageous manner. Local load peaks and resulting damage, in particular breakage, of the ferrites can thus be avoided.

In an advantageous embodiment of the invention, the housing is formed from an elastically deformable or flexible material, such that the housing can for example yield to or deflect under external influences, in particular actions of force, in a particularly advantageous manner. Local load peaks can be avoided in this way.

In a further embodiment of the invention, the ferrites are arranged on a surface, facing toward the ferrites, of the connecting element, and are preferably connected to the surface. The ferrites are thus for example arranged on the connecting element, whereby the ferrites can be connected to one another in a particularly simple manner by way of the connecting element.

In a further embodiment of the invention, the connecting element is arranged at least partially between the ferrites formed for example as ferrite cores, such that, for example, the ferrites can be connected to one another in a particularly advantageous manner. If the connecting element is for example arranged exclusively between the ferrites, the structural space requirement of the structural unit can be kept particularly small. Furthermore, in this case, the connecting element is for example part of the panel element, such that the structural space requirement can be kept particularly small.

To be able to keep the number of parts and the weight particularly low, provision is made, in a further embodiment of the invention, whereby the connecting element is formed as a single piece and/or as a foil.

A further embodiment of the invention provides for the ferrites to be arranged in the manner of a matrix in rows running mutually parallel and columns running mutually parallel and in each case perpendicular to the rows. The magnetic field can be conducted in a particularly advantageous manner in this way.

Provision may furthermore be made whereby the ferrites are arranged in a stellate manner, in order to thereby be able to realize particularly advantageous conducting and shielding of the magnetic field.

In order, for example, to be able to charge the energy store in a particularly advantageous, in particular efficient, manner even if the ferrites are moved relative to one another or if the connecting element has been elastically deformed, provision is made, in one embodiment of the invention, whereby the ferrites are of arcuate form on respective mutually facing end sides, in particular narrow sides. In this way, for example, a respective spacing between the ferrites remains at least substantially constant if the ferrites are moved relative to one another with elastic deformation of the connecting element or if the connecting element is elastically deformed in relation to an initial state.

Here, it has proven to be particularly advantageous if a respective first of the end sides has a convex positive contour and a respective second of the end sides, directly opposite the respective first end side, has a concave negative contour corresponding to the positive contour.

Finally, it has proven to be particularly advantageous if the ferrites engage into one another. In this way, the electrical energy can be inductively transmitted in a particularly advantageous manner even if the ferrites are moved relative to one another or if the connecting element has been elastically deformed.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic and sectional side view of a coil device according to a first embodiment for a motor vehicle, having ferrites which form an areal element and which are connected to one another by at least one elastically deformable connecting element, such that the ferrites are movable relative to one another with elastic deformation of the connecting element.

FIG. 2 is a schematic and sectional side view of a structural unit, comprising the ferrites and the connecting element, according to the first embodiment.

FIG. 3 is a schematic and sectional side view of the structural unit according to a second embodiment.

FIG. 4 is a schematic and sectional side view of the structural unit according to the first embodiment in a deformed state.

FIG. 5 is a schematic plan view of the structural unit according to the first embodiment.

FIG. 6 is a schematic plan view of the structural unit according to a third embodiment.

FIG. 7 is, in a detail, a schematic and sectional side view of the structural unit.

FIG. 8 is, in a detail, a schematic plan view of the structural unit according to a fourth embodiment.

FIG. 9 is, in a detail, a schematic and sectional side view of the structural unit according to a fifth embodiment.

FIG. 10 is a schematic plan view of one of the ferrites according to the fifth embodiment.

### DETAILED DESCRIPTION OF THE DRAWINGS

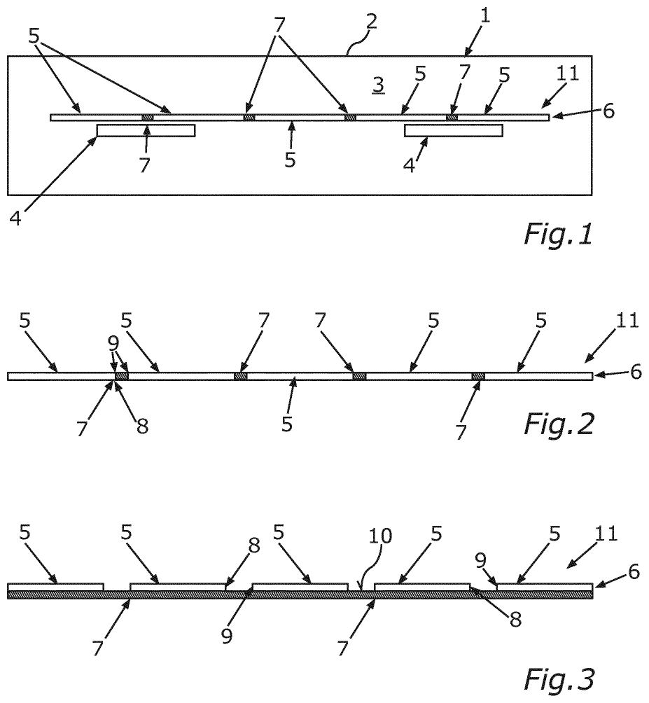

FIG. 1 shows, in a sectional side view, a coil device 1 for a motor vehicle, in particular for a car, such as for example a passenger car. The coil device 1 is part of an inductive charging unit, by which an energy store, designed for storing electrical energy, of the motor vehicle can be inductively charged with electrical energy. The motor vehicle is in this case for example in the form of a hybrid or electric vehicle and has at least one electric machine by which at least one wheel of the motor vehicle, or the motor vehicle as a whole, can be electrically driven. For this purpose, the electric machine is operable in a motor mode and thus as an electric motor. In order to operate the electric machine in the motor mode, the electric machine is supplied with electrical energy stored in the energy store. As a result, an amount of electrical energy stored in the energy store decreases. In order to increase the amount of electrical energy stored in the energy store again, the energy store is charged. For this purpose, for example, an energy source provides electrical energy by way of a primary coil (not shown in the figure) of the inductive charging unit. The energy source is for example an electrical grid or a charging pole connected to an electrical grid of said type. The primary coil is for example arranged on a floor on which the motor vehicle is supported, or stands, by way of its wheels.

Here, the coil device 1 is a constituent part of the motor vehicle and is held at least indirectly on a body, in particular on a self-supporting bodyshell, of the motor vehicle. The coil device 1 has a housing 2 and has a secondary coil 4 arranged in the housing 2, in particular in an accommodating space 3 of the housing 2. For example, multiple secondary coils 4 may be arranged in the housing 2. The secondary coil 4 may interact with the primary coil such that the electrical energy provided by the energy source by way of the primary coil is inductively transmitted from the primary coil to the secondary coil. The electrical energy transmitted to the secondary coil 4 is conducted from the secondary coil 4 to the energy store and is stored in the energy store. The energy store is for example in the form of a battery, in particular a high-voltage battery (HV battery), and has an electrical voltage, in particular an electrical operating voltage, of several hundred volts. In this way, it is possible to realize high levels of electrical power for the electric drive of the motor vehicle.

The coil device 1 furthermore has a plurality of ferrites 5 which are formed for example as ferrite cores and which are spaced apart from one another in pairs. For the inductive transmission of the electrical energy from the primary coil to the secondary coil 4, at least one magnetic field is generated which is conducted and shielded by means of the ferrites 5, which are formed for example as ferrite cores. In this way, a particularly efficient inductive and thus contactless transmission of energy can be realized. The ferrites 5 themselves are rigid, that is to say are not elastically or resiliently elastically deformable. Since the ferrites 5 are spaced apart from one another in pairs, a segmented arrangement or a segmented construction of the ferrites 5 is provided, such that the respective ferrite 5 is also referred to as a segment or ferrite segment.

To now realize a particularly high level of protection of the ferrites 5 against undesired damage and destruction, the ferrites 5 form an areal element, also referred to as panel element 6. This means that the ferrites 5 are arranged adjacent to one another in a common plane, wherein said plane is spanned by a first spatial direction and by a second spatial direction running perpendicular to the first spatial direction, in particular in relation to an installed position of the coil device 1. In particular, the coil device 1 assumes its installed position in a fully produced state of the motor vehicle. In this fully produced state of the motor vehicle, the coil device 1 is arranged for example on, in particular under, an underfloor of the motor vehicle, wherein the underfloor is formed for example by the body, in particular by the self-supporting bodyshell. In this way, the coil device 1 or the secondary coil 4 can be arranged particularly close to the primary coil in order to thereby be able to realize a particularly efficient transmission of energy.

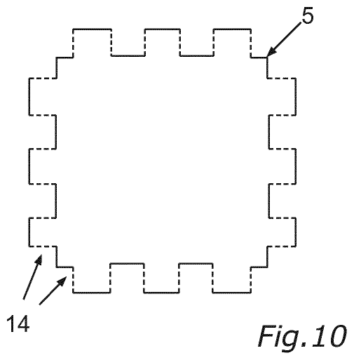

Here, the panel element 6 has an at least substantially areal extent. This is to be understood in particular to mean that the panel element 6 has a first extent running along the first spatial direction and a second extent running along the second spatial direction and thus perpendicular to the first extent. Furthermore, the panel element 6 has a third extent running perpendicular to the first extent and perpendicular to the second extent, which third extent runs along a third spatial direction running perpendicular to the first spatial direction and perpendicular to the second spatial direction, such that the third spatial direction runs perpendicular to said plane. Here, the first extent and the second extent are significantly greater than the third extent. The same applies for example analogously to the respective ferrite 5, such that the respective ferrite 5 is for example—as can be seen particularly clearly from FIG. 10—formed as a panel element and, here, as a plate or ferrite plate. The panel element 6 or the respective plate is in this case arranged in said plane.

Furthermore, to realize particularly advantageous protection of the ferrites 5 against external actions, in particular force influences, provision is made whereby the coil device 1 has at least one elastically deformable connecting element 7, by means of which the ferrites 5 are connected to one another, such that the ferrites 5 are movable relative to one another with elastic deformation of the connecting element 7.

FIGS. 1, 2, 4 and 5 illustrate a first embodiment of the coil device 1. In the first embodiment, multiple connecting elements 7 spaced apart from one another in pairs are provided, which connecting elements are flexible or elastically deformable and are thus formed from a flexible or elastically deformable material. The respective connecting element 7 is in this case arranged in each case at least partially, in particular at least predominantly or entirely, between the respective ferrites 5. In particular, the respective connecting element 7 is arranged between two immediately or directly mutually facing end sides 8 and 9 of in each case two of the ferrites 5, wherein the respective connecting element 7 is connected, in particular directly, to the respective end sides 8 and 9. The respective end sides 8 and 9 are respective narrow sides of the respective ferrite 5.

In the first embodiment, the connecting elements 7 are themselves mutually separate structural parts which are connected to the ferrites 5 and which are thus connected to one another by way of the ferrites 5. Furthermore, the connecting elements 7 are spaced apart from one another. In the first embodiment, the connecting elements 7 are thus likewise formed as segments and in this case as elastically deformable or elastic elements or segments which permit a relative movement between the ferrites 5, which are themselves rigid. In the first embodiment, the respective connecting elements 7 are likewise arranged in the plane common to the ferrites 5 and the connecting elements 7, such that, in the first embodiment, it is for example the case that the connecting elements 7 belong to the panel element 6. Here, it is for example the case that the connecting elements 7 do not project beyond the ferrites 5 along the third spatial direction and are for example thus, along the third spatial direction, arranged flush with the ferrites 5 or set back with respect to the ferrites 5. In the first embodiment, it is thus for example the case that a mixture of respective ferrite 5 and respective connecting element 7 is provided, which connecting element is formed for example from an elastic material which does not change respective magnetic characteristics during movement. The elastic material is for example plastic.

FIG. 3 shows a second embodiment, in the case of which, for example, exactly one connecting element 7 is provided. The connecting element 7 is in this case for example in the form of a foil and has a surface 10 which, in particular along the third spatial direction, faces toward the ferrites 5 that are common to the surface 10. The respective ferrites 5 are in this case arranged on the surface 10 and fastened to the surface 10, such that the ferrites 5 are arranged on the connecting element 7. Here, the connecting element 7 is not arranged between the ferrites 5, such that the connecting element 7 is, with respect to the end sides 8 and 9, arranged so as not to overlap the ferrites 5. A layered structure is thus provided in the third embodiment. In the respective embodiment, the ferrites 5 and the respective connecting element 7 are for example constituent parts of a structural unit denoted as a whole by 11, which structural unit, for example in the first embodiment, corresponds to the panel element 6. In the second embodiment, however, the structural unit 11 has a layered structure. The layered structure has a first layer formed by the panel element 6 and thus by the ferrites 5 and has a second layer which is formed by the connecting element 7. Here, the first layer is arranged on the second layer, such that the layers are arranged for example in respective planes which run perpendicular to the third spatial direction and which are spaced apart from one another along the third spatial direction.

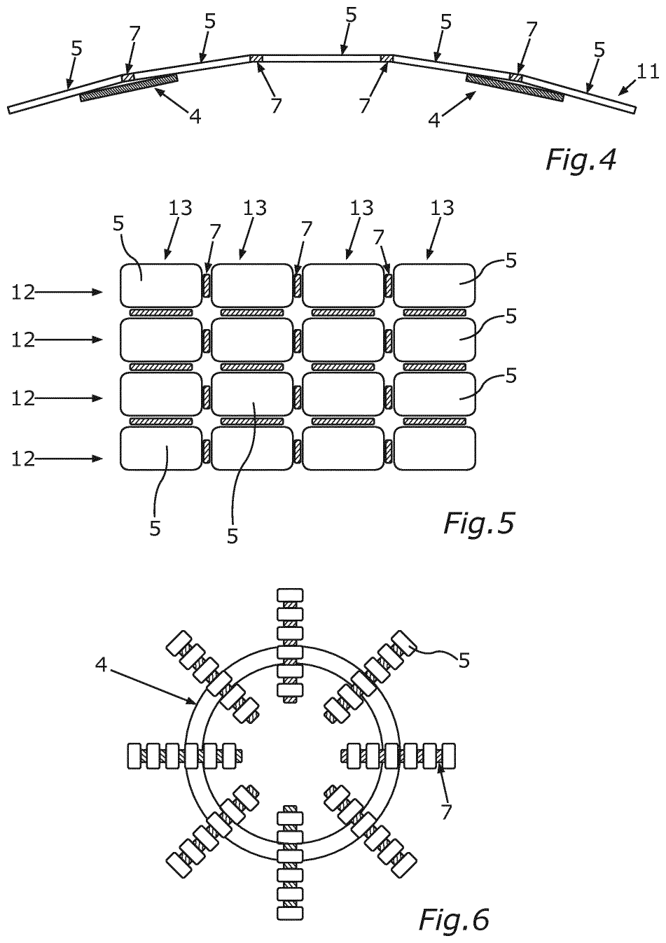

As can be seen particularly clearly from FIG. 4, the structural unit 11 is, for example in the event of an external action of force, elastically deformed without overloading of the respective ferrites 5 occurring. In other words, owing to the segmented construction and the connection of the ferrites 5 by means of the elastically deformable connecting element 7, the structural unit 11 can yield to or deflect under an external action of force. In this way, the structural unit 11 can accommodate external forces in a particularly advantageous manner, which external forces can be distributed in the structural unit 11, and thus accommodated by the structural unit 11, in a particularly effective manner. In this way, local load peaks and thus overloading of the ferrites 5 can be avoided, such that the likelihood of damage to or destruction of the ferrites 5 occurring can be kept particularly low. The segmented construction is also referred to as link-like structure, because, for example, the ferrites 5 constitute respective links which are movably connected to one another by means of the respective connecting element 7.

FIGS. 1 to 3 show the structural unit 11 in an initial state, wherein FIG. 4 shows the structural unit in a deformed state in which it has been elastically deformed in relation to the initial state. For example, the structural unit 11 is brought from the initial state into the deformed state by virtue of an external force acting on the structural unit 11. This arises for example if an object that is initially situated on a roadway along which the motor vehicle is being driven strikes the structural unit 11 or the coil device 1. In the deformed state, the respective connecting element 7 is deformed more intensely than in the initial state, such that the respective connecting element 7 provides a spring force, for example. When said external force is no longer acting on the structural unit 11, the respective connecting element 7 can for example deform back automatically or of its own accord. In other words, the respective connecting element 7 springs back, such that the structural unit 11 then assumes its initial state again.

FIG. 5 shows the first embodiment in a plan view. Here, the ferrites 5 are arranged quadratically or in a matrix-like manner in rows 12 running mutually parallel and columns 13 running mutually parallel and in each case perpendicular to the rows 12. In a third embodiment shown in FIG. 6, the ferrites 5 are arranged in a stellate manner.

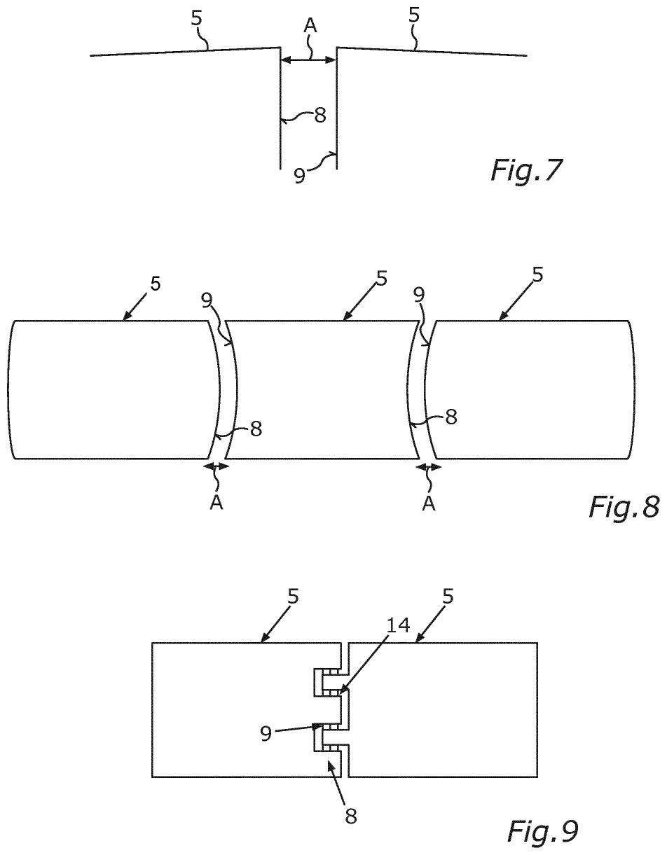

If no corresponding measures are implemented, then it is for example the case that respective spacings between the ferrites 5 change if these are moved relative to one another with elastic deformation of the respective connecting element 7. In other words, for example, a respective spacing between the ferrites 5 in the initial state is constant along at least one extent of the spacing, but, in the deformed state, the spacing varies along its extent. In this way, the magnetic characteristics between the ferrites 5 can change. This is illustrated in FIG. 7. In FIG. 7, A denotes the spacing between in each case two mutually directly adjacent ferrites 5, wherein the spacing A varies along its extent, for example along the third spatial direction, if the structural unit 11 is elastically deformed.

FIG. 8 shows a fourth embodiment, by means of which, for example, the spacing A can be kept at least substantially homogeneous or constant even in a deformed state of the structural unit 11. In other words, the spacing A between the ferrites 5, which are themselves solid or rigid, can be fixed. Here, it is for example the case that an external shape of the ferrites 5 is designed or constructed such that the function remains the same. This is realized in the fourth embodiment in that the respective, mutually directly or immediately adjacent ferrites 5 are of arcuate form on their end sides 8 and 9 directly facing one another, which end sides are in particular formed as narrow sides. Here, the respective end side 8 is of convex form and thus has a convex positive contour. The respective end side 9 is concave and thus has a concave negative contour corresponding to the positive contour.

In the fourth embodiment, the end sides 8 and 9, also referred to as end faces, are of at least substantially rounded form. Thus, the spacing A between the ferrites 5 remains at least substantially homogeneous or equal or constant, in particular even if the structural unit 11 is deformed.

The spacing A between the ferrites 5 is constituted for example by the respective connecting element 7 formed as an elastic segment. The respective connecting element 7 is for example formed from a flexible or elastically deformable material and ferrite powder, wherein the ferrite powder is for example embedded into the flexible material. This realization ensures an unchanged function even in the event of a shock loading during the inductive transmission of energy and thus during a charging process during the course of which the energy store is charged, because the ferrites 5 move relative to one another only to a very small extent, and resulting small variations are negligible. Here, the spacing A varies for example by less than 5 percent, such that a particularly efficient charging process can be realized as before.

Finally, FIGS. 9 and 10 show a fifth embodiment, in which the ferrites 5 engage into one another. Since the magnetic flux passes via the end sides 8 and 9 and thus via side surfaces, the same function would be ensured during deformation of the structural unit 11 even during the charging process. Altogether, it is evident that the structural unit 11 can be deformed by external action of force without being destroyed and without being damaged, in particular elastically. In this way, the structural unit 11 yields to external actions of force, whereby it is possible to avoid breakage of the ferrites 5. Furthermore, in FIGS. 9 and 10, surfaces for the transmission of flux are illustrated by dashed lines and are denoted by 14.

The housing 2 is preferably formed from a leak-tight and deformable, in particular elastically deformable, and thus flexible material, such that the housing 2 can also deflect under or yield to external actions of force. Depending on requirements, different forms of the secondary coil 4 are furthermore conceivable. In particular, the fourth embodiment and the fifth embodiment make it possible for the inductive energy transmission and thus the charging process to be carried out efficiently even in the deformed state of the structural unit 11, such that the energy store can be charged in an advantageous manner.

### LIST OF REFERENCE DESIGNATIONS

1 Coil device
2 Housing
3 Accommodating space
4 Secondary coil
5 Ferrite
6 Panel element
7 Connecting element
8 End side
9 End side
10 Surface
11 Structural unit
12 Row
13 Column
14 Surface
A Spacing

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A coil device for a motor vehicle, comprising:
a housing;
at least one secondary coil which is arranged in the housing and which serves for inductively transmitting electrical energy for purposes of charging an energy store of the motor vehicle; and
a plurality of ferrites which are arranged in the housing and which are spaced apart from one another and serve for conducting at least one magnetic field for inductive transmission of the electrical energy, wherein
the ferrites form an areal element and are connected to one another by at least one elastically deformable connecting element such that the ferrites are movable relative to one another with elastic deformation of the connecting element.

2. The coil device according to claim 1, wherein
the housing is formed from an elastically deformable material.

3. The coil device according to claim 1, wherein
the ferrites are arranged on a surface of the connecting element that faces the ferrites.

4. The coil device according to claim 1, wherein
the connecting element is arranged at least partially between the ferrites.

5. The coil device according to claim 1, wherein
the connecting element is formed as a single piece and/or as a foil.

6. The coil device according to claim 1, wherein
the ferrites are arranged in a matrix in rows running mutually parallel and columns running mutually parallel and in each case perpendicular to the rows.

7. The coil device according to claim 1, wherein
the ferrites are arranged in a stellate manner.

8. The coil device according to claim 1, wherein
the ferrites are of arcuate form on respective mutually facing end sides.

9. The coil device according to claim 8, wherein
a respective first of the end sides has a convex positive contour and a respective second of the end sides, opposite the respective first end side, has a concave negative contour corresponding to the positive contour.

10. The coil device according to claim 1, wherein
the ferrites engage into one another.
